(19) United States
(12) Patent Application Publication
(10) Pub. No.: US 2025/0219124 A1
(43) Pub. Date: Jul. 3, 2025

(54) APPARATUS AND RELATIVE METHOD OF WINDING A STRIP OF MATERIAL, IN PARTICULAR FOR THE PRODUCTION OF ELECTRICAL ENERGY STORAGE DEVICES

(71) Applicant: MANZ ITALY S.R.L., SASSO MARCONI (BO) (IT)

(72) Inventors: Massimiliano Sale, SASSO MARCONI (BO) (IT); Pantaleone Barbieri, SASSO MARCONI (BO) (IT)

(73) Assignee: MANZ ITALY S.R.L., SASSO MARCONI (BO) (IT)

(21) Appl. No.: 18/850,389

(22) PCT Filed: Mar. 28, 2023
(86) PCT No.: PCT/IB2023/053085

§ 371 Date: Sep. 24, 2024

(30) Foreign Application Priority Data
Mar. 30, 2022 (IT) 102022000006263

(51) Int. Cl. H01M 10/04; B65H 18/10; B65H 23/04; B65H 39/16

(52) U.S. Cl. CPC H01M 10/0409; B65H 18/103; B65H 39/16; B65H 23/048; B65H 2301/41462; B65H 2404/143; B65H 2404/1441; B65H 2701/19

(57) ABSTRACT

An apparatus for winding at least one strip of material is described, the apparatus comprises: a winding core rotatable about a rotation axis, configured to grip said strip and actuatable in rotation to drag the gripped strip and thus form a winding around the rotation axis from a portion of predetermined length of strip; and a feeding unit for feeding the strip of material to the winding core along a respective feed path extending from the feeding unit to the winding core; the apparatus further comprising an auxiliary drag device interposed between the feeding unit and the winding core, along the feed path, and configured to pull the strip of material from the feeding unit and push it towards the winding core, so as to assist the winding core in dragging the strip.

### CROSS-REFERENCE TO RELATED APPLICATIONS

This Patent Application claims priority from Italian Patent Application No. 102022000006263 filed on Mar. 30, 2022, the entire disclosure of which is incorporated herein by reference.

### TECHNICAL SECTOR

The present invention relates to an apparatus and a relative method for winding a strip of material, in particular a plurality of strips of material, e.g. at least one electrode strip and at least one separator strip, preferably for the production of electrical energy storage devices.

In particular, the present invention may be advantageously but not exclusively applied to the production of capacitors or rechargeable batteries, more specifically to the production of cylindrical rechargeable batteries or in any case comprising cylindrical windings, to which the following description will make explicit reference without losing generality.

### BACKGROUND

Automatic machines are known for the production of electrical energy storage devices, and in particular rechargeable batteries or capacitors.

Rechargeable batteries usually comprise two electrode layers (cathode and anode) and at least two separator layers arranged as offset from each other in an alternating electrode-separator-electrode-separator pattern.

The aforesaid layers are obtained from continuous strips of material (electrode or separator) that are cut at predetermined lengths.

In the case of the above-mentioned cylindrical batteries, the automatic machines comprise winding apparatuses which are configured to feed, via respective feeding units, the electrode and separator strips along different feed paths that all converge towards a rotating winding core.

Such a winding core is configured to hold and wind, generally about an elongated-shaped support (known as a “pin”), the electrode and separator strips arranged as offset from each other, to form a cylindrical winding.

In detail, known winding apparatuses (and the relative methods) involve firstly feeding only the separator strips to the winding core and then, after the separator strips have been gripped by the winding core and have completed at least a couple of winding turns around it, the electrode strips according to the alternating pattern mentioned above.

Thereby, the electrode strips, before or after being cut at the desired length, are held and dragged in rotation between the separator strips so as to form a winding.

In greater detail, a winding apparatus of the known type includes:
a first feeding unit configured to feed two separator strips, along respective feed paths, to the winding core, in particular initially spaced apart and subsequently converging at the winding core; and
a second feeding unit configured to feed the two electrode strips, i.e. the cathode and the anode, to the winding core along their respective feed paths.

Generally, the cathode is fed along a feed path between the feed paths of the separator strips, while the anode is fed along a feed path converging with the winding core so as to be placed above one of the separator strips, in particular the one radially inward with respect to the winding.

Thereby, the cathode strip is fed to the winding core already interposed between the two initially open separator strips, so that the aforementioned alternating electrode-separator-electrode-separator pattern (in detail, anode-separator-cathode-separator) is obtained.

The separator strips are initially wound into respective coils, each of which is rotationally supported by a respective shaft or spindle of the first feeding unit.

Similarly, the electrode strips are initially wound into respective coils, each of which is rotationally supported by a respective shaft or spindle of the second feeding unit.

The winding apparatuses of the known type also include respective cutting units configured to cut the respective strips (separator and electrode) once the preset winding length of each strip has been reached, i.e. once the nominal radius of the winding has been reached.

Preferably, the electrode strips are cut by the respective cutting units before the winding is finished, i.e. before the end of the winding process, while at least one further winding turn is made with the separator strips only.

Subsequently, the latter are also cut by the respective cutting unit and the cut flaps are rewound by the winding core to form the last concentric layers of the winding, while the strips are held by respective gripping units of the winding apparatus.

Once finished the winding step, the winding is closed, for example by a portion of an adhesive tape, in what is known as a “taping” operation.

In this regard, the winding core is typically mounted on a rotating platform of the winding apparatus arranged and configured so that at each rotation step of said platform, the winding core is moved between a winding station, where the aforementioned winding operation is performed and the winding is formed, and a closing (or “taping”) station, where the already formed winding is closed by further winding with a portion of adhesive tape at least partially around it (to secure the hanging flap to the rest of the winding).

In some known configurations, the rotating platform includes an additional rotation step to move the winding, sequentially, between the winding station, the closing station and an unloading station, where the finished and closed winding is unloaded to be subsequently inserted into a can (e.g. cylindrical and made of metal).

Typically, the winding apparatus thus comprises three winding cores (and thus three “pins”), which are carried by the rotating platform and are moved by it, selectively and sequentially, between the winding station, the closing station and the unloading station.

In use, the aforementioned “pin” of each winding core grips the separator and electrode strips and drags or “pulls” them towards itself in winding, thus causing the strips to be progressively unwound from their respective coils and wound around the pin to create the cylindrical winding.

Each cylindrical winding consists of several metres (even hundreds) of separator and electrode strips, which are dragged (i.e. towed or pulled) by the pin of the winding core.

In practice, the pin is actuated in rotation about its own axis and drags the separator and electrode strips being unwound from their respective coils, while the respective spindles accompany the unwinding of the strips from these coils.

In addition, each pin usually has a small diameter in order to allow making a compact winding.

It is therefore clear that each pin is subjected, in use, to high torsional and bending stresses, in particular a fatigue load, which intensifies as the production speed and specific weight of the separator strips and, above all, electrode strips, increase.

Such stresses may lead to deformation, weakening or, in some cases, breaking of the pin after a certain number of cycles.

To avoid this, the known solutions involve thickening the pin or reducing the production speed.

Although the known winding apparatuses (and relative methods) are structurally and functionally sound, the Applicant noted that they are susceptible to further improvements, in particular as regards to the service life of the winding core, the increase in production speed and the reduction of total costs and replacement times of the pins.

### OBJECT AND SUMMARY OF THE INVENTION

The aim of the present invention is to make an apparatus for winding (at least) a strip of material and a related method which are highly reliable and cost-effective, and which enable to fulfil at least some of the requirements specified above and related to the above-mentioned winding apparatus and methods of a known type.

According to the invention, this aim is achieved by a winding apparatus and a relative method as claimed in the hereinafter independent claims, and preferably in any one of the claims depending directly or indirectly on the independent claims.

The claims describe preferred embodiments of the present invention forming an integral part of the present description.

### BRIEF DESCRIPTION OF THE DRAWINGS

For a better understanding of the present invention, a preferred non-limiting embodiment is described below, purely by way of example and with the aid of the attached drawings, wherein:

FIG. 1 is a schematic side view, with parts removed for the sake of clarity, of a first portion of a winding apparatus made according to the present invention;

FIG. 2 is a schematic side view, with parts removed for the sake of clarity, of a second portion of the winding apparatus of FIG. 1 arranged operationally upstream of the first section;

FIG. 3 is a perspective view, enlarged in scale and with parts removed for the sake of clarity, showing some components of the winding apparatus of FIG. 1;

FIGS. 4 and 5 show in a perspective view, from opposite sides, on an enlarged scale and with parts removed for the sake of clarity, an auxiliary drag device of the winding device as visible in FIG. 3.

### DETAILED DESCRIPTION

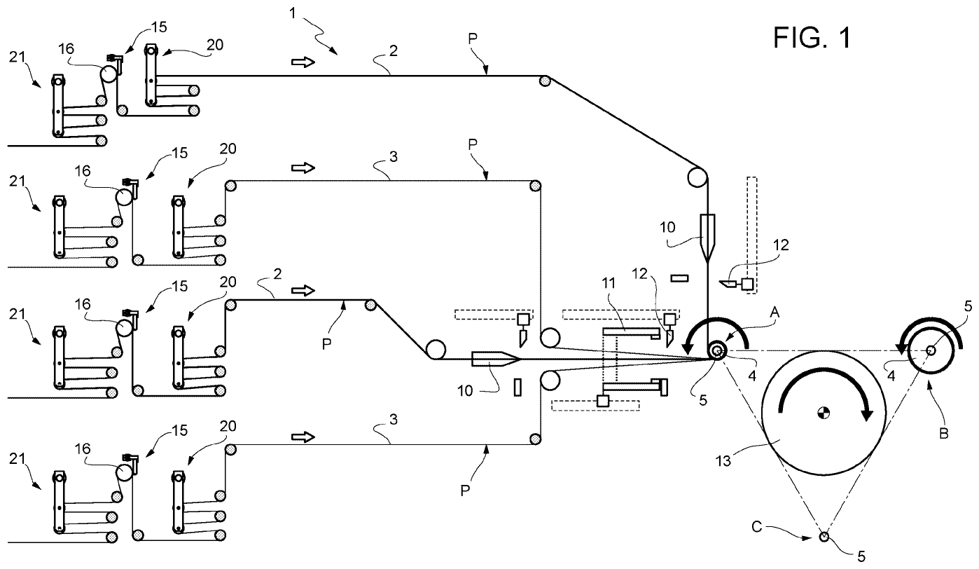

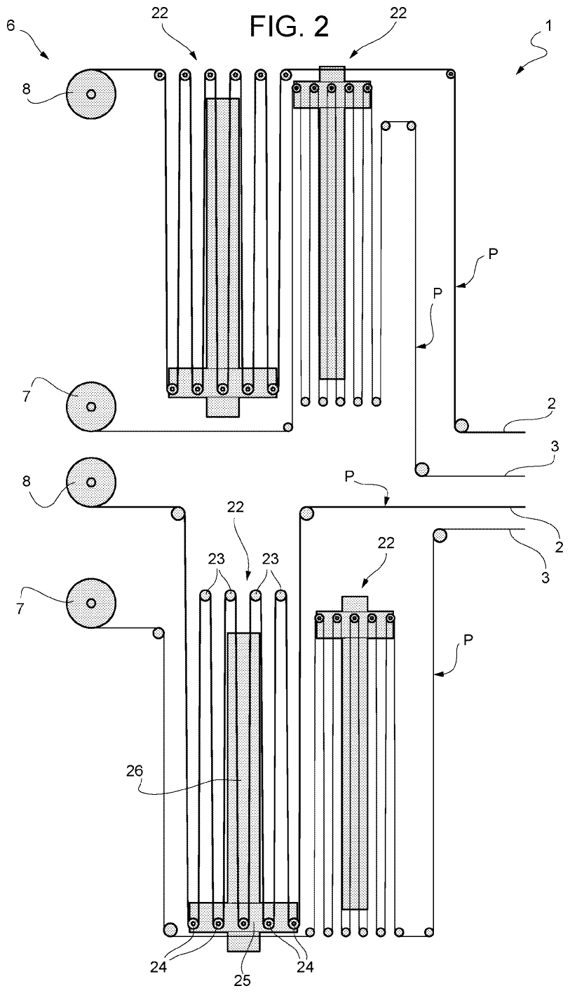

With reference to FIGS. 1 and 2, an apparatus for winding at least one strip of material is globally denoted by 1.

In particular, the apparatus 1 is configured to wind electrode strips 2 and separator strips 3 for the production of electrical energy storage devices, to which the following description will make explicit reference without losing generality.

More specifically, the apparatus 1 is configured to wind electrode strips 2 and separator strips 3 onto themselves to form a winding 4, preferably cylindrical or oval.

Therefore, the present invention may be advantageously, but not exclusively, applied to the production of capacitors or rechargeable batteries, more particularly to the production of cylindrical or oval rechargeable batteries comprising cylinder- or oval-shaped windings 4, to which the following description will make explicit reference without losing generality.

Alternatively, the apparatus 1 could be configured for winding one or more strips of any material, such as paper.

Rechargeable batteries comprise two electrode layers (cathode and anode) and at least two separator layers arranged as offset from each other in an alternating electrode-separator-electrode-separator pattern.

These layers are obtained from the aforementioned continuous strips 2, 3, which are cut at predetermined lengths to form a sequence of cylindrical windings 4.

These cylindrical windings 4 are then arranged, in a known process downstream of the apparatus 1, inside containers (usually made of metal) which are then filled with an electrolyte to form a respective rechargeable jelly roll battery.

Therefore, in this case, the apparatus 1 is used to wind two electrode strips 2, a cathode and an anode, and two separator strips 3 arranged as offset from each other according to the aforementioned alternating pattern, so as to form a battery or capacitor, or more specifically a battery module or capacitive unit of a capacitor.

FIG. 1 shows a first section of the apparatus 1, while FIG. 2 shows a second section of the apparatus 1, which is operationally arranged upstream of the first section.

As shown in FIGS. 1 and 2, the apparatus comprises:
a winding core 5 (FIG. 1) rotatable about a rotation axis, configured to grip strips 2, 3 and actuatable to drag the gripped strips 2, 3 to form a winding 4 from a predetermined length portion of each strip 2, 3 (about the rotation axis); and
a feeding unit 6 (FIG. 2) configured to feed strips 2, 3 to the winding core 5 along respective feed paths P, distinct from each other, which extend from the feeding unit 6 to the winding core 5, all converging at the latter.

In detail, the feeding unit 6 comprises (FIG. 2):
a first feeding device 7 configured to feed the two separator strips 3 to the winding core 5; and
a second feeding device 8 configured to feed the two electrode strips 2 to the winding core 5.

In greater detail, the first device 7 consists of two coils 7, each of which contains a certain amount of separator strip 3 wound around a hollow central core capable of being engaged by a respective motorised support shaft or spindle.

Similarly, the second device 8 consists of two coils 8, each of which contains a certain amount of electrode strip 2 wound around a hollow central core capable of being engaged by a respective motorised support shaft or spindle.

The winding core 5 comprises a so-called “pin” (known as such and not shown), which consists of a bar formed by two elongated elements rotatable about the rotation axis and movable along a direction parallel to the rotation axis between an opening configuration, wherein the elements are offset from each other, and a gripping configuration, in which the elements are at least partially facing each other to grip the strips 2, 3 between them, so as to be able to drag them in rotation and to determine the progressive formation of the winding 4 about the rotation axis.

In use, the strips 2, 3 are unwound from their respective coils 7, 8 and fed along their respective feed paths P and up to the winding core 5. The latter, once the strips 2, 3 have been gripped, is actuated in rotation around its own axis, causing the strips 2, 3 themselves to be dragged or pulled (being unwound) from the coils 7, 8.

In other words, it is the winding core 5, by means of the actuation in rotation, that determines the unwinding of strips 2, 3 from the coils 7, 8, respectively.

Conveniently, the feeding unit 6 feeds, in use, a first electrode strip 2 (e.g. the cathode) at a position interposed between the two separator strips 3.

In greater detail, the feed path P of the cathode 2 lies between the feed paths P of the separators 3.

Conveniently, the feed path P of the other electrode strip 2 (e.g. the anode) is positioned in such a way that the anode 2 strip 2 itself is placed above the separator strip 3 radially inwards with respect to the winding 4.

Thereby, the cathode strip 2 is fed to the winding core 5 already interposed between the two separator strips 3, initially spaced apart, so as to obtain the aforementioned alternating electrode-separator-electrode-separator pattern (in detail, anode-separator-cathode-separator).

The strips 2, 3, i.e. the feed paths P, all converge at the winding core 5.

Preferably, the apparatus 1 comprises a control unit (known in itself and neither illustrated nor described in detail) configured to control the actuation in rotation of the winding core 5, as well as to control the feeding unit 6, i.e. the motorised spindles supporting the coils 7, 8.

In particular, the control unit is configured to control the feeding of the strips 2, 3 in such a way that the cathode strip 2 is introduced (fed) between the separator strips 3 once they are gripped at the core 5, more precisely once these separator strips 3 have been wound for at least a couple of turns around the winding core 5.

Advantageously, the second electrode strip 2, in the specific non-limiting case the anode, is also fed to the core 5 once the separator strips 3 have been wound for at least a couple of turns around the winding core 5.

The aforementioned support spindles of the coil 7, 8 are motorised in order to be actuated in rotation to compensate for the transients of the winding core 5.

More precisely, should irregularities arise in the tension of the strips 2, 3 or should differences arise in the rotation speed between the pin of the core 5 and the respective spindles (especially in the transient step, i.e. at the beginning and end of the winding of each winding 4), the spindles act by compensating for the tension, in a known manner.

Conveniently, the apparatus 1 also includes guide members 10, grippers 11 and cutting devices 12 whose operation is known, for example from Patent Application No. IT102021000021314, to the same Applicant and therefore will not be described in detail. Briefly: the guide members 10 are each configured to grip a respective electrode strip 2 and feed it towards the core 5 at the electrode feed rate to avoid unwanted stretching or tensioning at the beginning of each winding; the grippers 11 are designed to grip the respective strips 2, 3 to facilitate cutting thereof; and the cutting devices 12 are configured to cut the strips at a certain length, once the desired size of the winding 4 is reached.

The operation of the guide members 10, grippers 11 and cutting devices 12 is described in the aforementioned Patent Application No. IT102021000021314.

As shown in FIG. 1, the apparatus 1 comprises a winding station A defining a convergence final end of the feed paths P and at which a winding 4 is formed cyclically by actuating in rotation the core 5. The apparatus 1 also includes:
a closing device (known in itself and neither illustrated nor described in detail) configured to close, with a layer of adhesive material, in a known manner, the winding 4 formed during a “taping” process and arranged at a closing station B (or “taping” station) operationally positioned downstream of the winding station A;
an unloading unit (known in itself and neither described in detail nor illustrated) of the formed and closed winding 4 arranged at an unloading station C operationally positioned downstream of the closing station B.

According to what has just been described, the core 5 is movable between the winding station A, where it receives the strips 2, 3 and winds them as explained above to form one winding 4 at a time, the closing station B, where said winding 4 is closed by the closing device, and the unloading station C, where the unloading unit unloads the formed and closed winding 4.

To this end, the apparatus 1 comprises a handling device, in particular a rotating platform, even more particularly a star wheel 13 rotatable about a rotation axis, preferably parallel to the rotation axis of the core 5, and configured to sequentially move the core 5 between the winding station A, the taping station B, the unloading station C and again the winding station A.

According to other embodiments not shown, the apparatus 1 may not include one of the closing station B or unloading station C.

Conveniently, the apparatus 1 comprises a plurality of winding cores 5, in particular three winding cores 5 carried by the wheel 13 and equally spaced about the rotation axis of the latter so as to occupy, each, one of the three stations A, B or C.

In other words, the control unit controls an angular displacement (e.g. 120° at a time) of the wheel 13 so that at each rotation step each core 5 is sequentially arranged at one of the three stations A, B, C mentioned above, to perform the entire winding process.

According to an aspect of the present invention, the apparatus 1 further comprises at least an auxiliary drag device 15 interposed between the feed unit 6 and the core 5, along at least one feed path P, and configured to pull the respective strip 2, 3 from the feeding unit 6 and push (i.e. feed or direct) it towards the core 5, so as to assist the core 5 itself in dragging the strip 2, 3.

In particular, the auxiliary drag device 15 is configured to grip the aforesaid strip 2, 3 and comprises a drag roller 16 arranged along the aforesaid feed path P in a position downstream of the feeding unit 6 and upstream of the core 5, and actuatable in rotation to pull the strip 2, 3 gripped by the feeding unit 6 and feed it towards the core 5.

Conveniently, the apparatus 1 comprises a plurality of drag devices 15, and thus a plurality of said drag rollers 16, in particular at least one for each electrode strip 2 or separator strip 3.

In the specific case shown, the apparatus 1 comprises four drag rollers 16, one for each of the aforementioned strips 2, 3, and each arranged along the respective feed path P at a position downstream of the respective coil 7, 8 and upstream of the core 5.

In the light of the above, each feed path P extends from the respective coil 7, 8 to the core 5, passing through the respective drag roller 16.

Thanks to this configuration, the pulling stresses to which the pin of the winding core 5, i.e. the aforementioned elongated bar, is subjected are reduced compared to the case where no auxiliary drag roller 16 is provided. In fact, each drag roller 16 pulls, i.e. drags, the respective strip 2, 3 from the relative coil 7, 8 for most of the respective feed path P, thus reducing the load on the pin of the core 5.

In addition, since there is a drag roller 16 for each strip 2, 3, such a load is distributed over each of the feed paths P, i.e. over each of the drag rollers 16, further reducing the stresses to which the pin of the core 5 is subjected.

Advantageously but not limitatively, the auxiliary drag device 15 is configured to be actuated in a manner subordinate to the (rotary) movement of the winding core 5 about the rotation axis and/or the length of said at least one of the two strips 2, 3 entering the winding 4.

In particular, the drag roller 16 is configured to be controlled in motion according to the movement of the winding core 5.

In certain non-limiting instances, the drag roller 16 is configured to be controlled so as to pull the same amount of strip 2, 3 entering the winding, i.e. the amount of strip 2, 3 pulled by the winding core 5. For the sake of brevity, reference will be made hereinafter to a single strip 2, 3, such as an anode strip 2, to a single feed path P and to a single drag device 15 arranged along said path P. However, the characteristics described for such a strip 2 and device 15 are equally applicable to the other strips 2, 3 and to the remaining devices 15.

Advantageously, the drag roller 16 is placed at a non-zero distance from the winding core 5, measured along the feed path P, less than ½ of the total length of the feed path P (extending from the coil 7, 8 to the core 5), preferably less than ⅓ of the total length of the feed path P, even more preferably less than ¼ of the total length of the feed path P, in particular less than ⅕ of the total length of the feed path P, more specifically less than ⅙ of the total length of the feed path P.

More precisely, the drag roller 16 is placed at a non-zero distance from the winding core 5, measured along the feed path P, less than 5 m, preferably less than 3 m, even more preferably less than 2 m.

In a preferred embodiment of the present invention, each drag roller 16 is arranged at a distance of between 1 m and 1.5 m from the core 5, over a total length of the relative feed path P, from the coil 7, 8 to the core 5, for example, higher than 10 m. Thereby, the drag roller 16 pulls the greater part of the strip 2, 3 towards itself, relieving the load exerted on the core 5, which must then actively drag only the last portion of the strip 2, 3 (i.e. of each strip 2, 3). Therefore, the service life of the core 5 is increased.

In addition, it is possible to increase the rotation speed of the core 5 and thus the production speed of the apparatus 1.

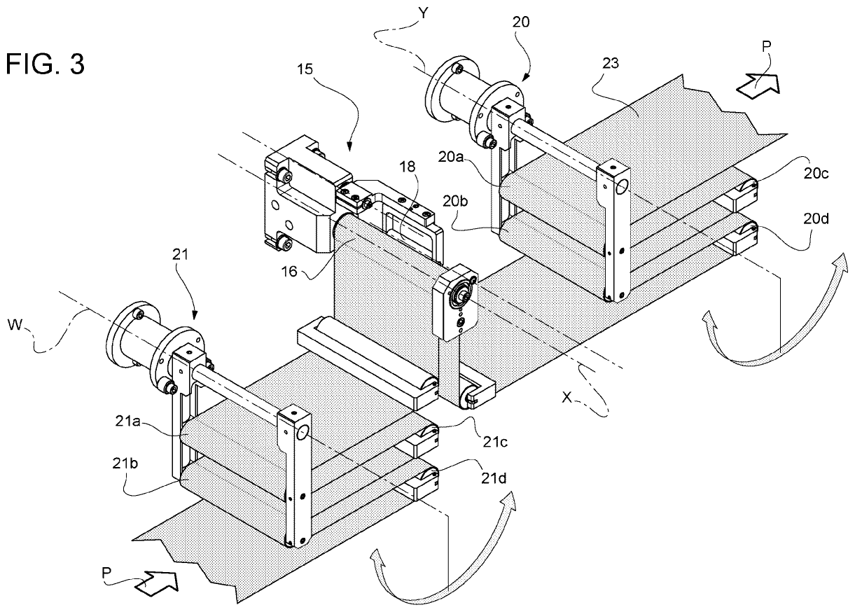

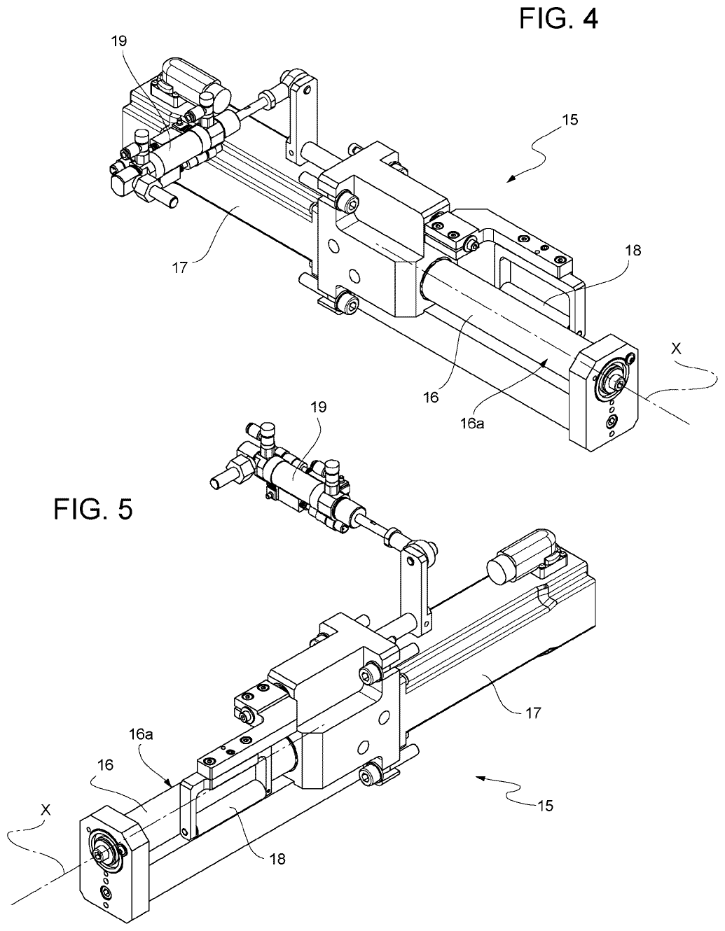

The drag device 15 comprises a first actuator 17 (FIGS. 4 and 5) configured to control the rotation of the drag roller 16 around its own axis X (FIG. 3), defining the rotation axis of the roller 16 itself.

Advantageously, the drag device 15 comprises, in addition to a drag roller 16, a counter roller 18 (FIGS. 3, 4 and 5) arranged adjacent to the drag roller 16 and configured to press against an outer lateral surface 16a of the drag roller 16 itself to determine the aforementioned gripping of the strip 2 at a position upstream of the core 5.

In practice, the strip 2 is gripped at said position upstream of the core 5 by clamping the counter roller 18 against the drag roller 16.

Preferably, the drag device 15 includes a second actuator 19 (FIGS. 4 and 5) operatively coupled with the counter roller 18 and configured to move the counter roller 18 from and towards the outer lateral surface 16a to adjust the gripping pressure of the strip 2 between the counter roller 18 and the drag roller 16.

In other words, the actuator 19 allows to adjust the distance between the counter roller 18 and the outer lateral surface 16a so that the pressure with which the counter roller 18 presses the strip 2 against the drag roller 16 can be adjusted.

This is particularly advantageous, as it increases the ability of the apparatus 1 to adapt to the strips 2, 3 with a different specific gravity per unit of length and with different elasticity and brittleness, since, as these factors vary, the above-mentioned pressure must be adapted.

In the specific non-limiting case shown, the counter roller 18 is a passive-type roller, i.e. not motorised in rotation, unlike the drag roller 16, which is therefore of the active type. Therefore, in use, the counter roller 18 is driven to rotate about its own axis by means of actuation in rotation of the roller 16 and by the interposition of the strip 2.

Preferably, the actuator 19 is of the hydraulic type.

The Applicant has observed, by means of an extensive testing, that this type of actuator 19 allows to optimally and precisely adjust the position of the counter-roller 18 and, therefore, of the clamping pressure of the strip 2.

Alternatively, the actuator 19 could be of the pneumatic, electric, electromagnetic type and so on.

As visible in FIGS. 1 to 3, the apparatus 1 comprises a first dancer roller member 20 arranged along the feed path P downstream of the drag roller 16 and upstream of the core 5 and controllable in tilting to adjust a tension of the strip 2 between the drag roller 16 and the core 5.

In the specific case shown, the apparatus 1 comprises four first members 20, one for each of strip 2, 3 and feed path P.

In other preferred but non-limiting cases, the drag roller 16 is configured to be controlled in rotation depending on the tilting position of the first dancer roller member 20; in particular, the drag roller 16 is configured to be controlled in rotation to keep the tilting position of the first dancer roller member 20 fixed. Thus, as previously said, the drag roller 16 assists the winding core 5 in pulling the strip 2, 3 of material.

Furthermore, advantageously but not limitatively, the pulling of the strip 2, 3 of material is transferred to the winding core 5, which is the master of the movement of the strip 2, 3 of material.

Preferably but not limitatively, the drag roller 16 is configured to be controlled so that its speed increases as the deviation from a rest position of the first dancer roller member 20 increases. In other words, the greater the deflection of the first dancer roller member 20 relative to the rest position (normally perpendicular to the strip feeding direction), i.e. with the machine at standstill or with the strip 2, 3 being pulled at a constant speed.

In other words, the drag roller 16, more generally the auxiliary drag device 15, is configured to be actuated with an alternating motion, thus alternating standstill steps and motion steps (with a variable speed).

Conveniently, the apparatus 1 further comprises a second dancer roller member 21 arranged along said feed path P downstream of the feeding unit 6 and upstream of the drag roller 16 and controllable in tilting to adjust a tension of the strip 2 between the feeding unit 6 and the drag roller 16.

In the specific case shown, the apparatus 1 comprises four second members 21, one for each strip 2, 3 and feed path P.

Preferably, the dancer members 21 are of the same type as the dancer members 20.

In practice, each drag roller 16 is operatively preceded by a second member 21 and operatively followed by a first member 20, along the respective feed path P of the relevant strip 2, 3.

As is well known, each dancer roller member 20, 21 supports the respective strip 2, 3 being fed along its feed path P and is able to tilt (or oscillate) about a rotation axis to adjust a tension of the strip 2, 3 itself (upstream of the drag roller 16, in the case of the second member 21, or downstream of the drag roller 16, in the case of the first member 20). In particular, the tension is adjusted by a special actuator (usually pneumatic, in particular which, in use, is configured to generate a constant tension of the strip 2, 3).

In some non-limiting cases, the angular position of the dancer roller member 20 adjusts the motion (particularly with a speed control) of the respective drag roller 16 upstream of the feed path P on which the dancer roller member 20 is located.

Alternatively or additionally, the angular position of the dancer roller member 21 adjusts the motion (in particular with a speed control) of the spindle or shaft of the respective coil 7, 8 upstream of the feed path P on which the dancer roller member 21 is located.

According to an aspect of the present invention, the first member 20 comprises at least a pair of dancer rollers 20a, 20b integral in tilting with each other and arranged in such a way that the respective feed path P passes through the first member 20 so that each dancer roller 20a, 20b of said pair supports in unwinding the strip 2, 3.

In particular, as shown in FIG. 3, the first member 20 has a rotation axis Y. The dancer rollers 20a, 20b are arranged spaced-apart from that axis Y, along a radial direction, and at a fixed distance from each other, and may be actuated to oscillate (or tilt) about such an axis Y.

More particularly, the first member 20 comprises at least one further pair of fixed rollers 20c, 20d, each one associated with a dancer roller 20a, 20b and adapted to support the respective strip 2, 3 in cooperation with the dancer rollers 20a, 20b.

More precisely, as visible in FIG. 3, the dancer rollers 20a, 20b and the fixed rollers 20c, 20d are positioned in such a way that the relative feed path P passing through the first member 20 defines four curves about the rollers 20a, 20b, 20c, 20d themselves and four straight sections sequentially interposed between the four curves, respectively.

In practice, the strip 2, 3 defines, through the first member 20, a “double S”-section of the feed path P. Thanks to this configuration, the angular movement of the member 20 will be smaller, with the same amount of required tension adjustment of the strip 2, 3.

In other words, an angular movement of the dancer rollers 20a, 20b around the axis Y will correspond to an adjustment (tension or loosening, possibly with associated acceleration or deceleration of the relative drag roller 16) of the respective strip 2, 3 which will be greater (in particular fourfold) than if the member 20 comprises only one dancer roller.

A finer tension adjustment of the strip 2, 3 is thus achieved, resulting in a smaller angular movement of the dancer rollers 20a, 20b. This results in a smaller wear of the first member 20 and thus in a further increased service life of the apparatus 1.

Advantageously, the second member 21 also comprises a pair of dancer rollers 21a, 21b and a pair of stationary rollers 21c, 21d, the arrangement and operation of which are similar (possibly with relative acceleration or deceleration of the unwinding of the respective coil 7, 8) to those of the first member 20, thus resulting in a further increase in the service life of the apparatus 1.

The presence of at least two dancer rollers 20a, 20b, 21a, 21b for each member 20, 21 also leads to a further reduction in the total load exerted on the pin of the core 5. In particular, the core 5 has a cross-section with a thickness of less than 1 cm, in particular less than 5 mm. In other words, the pin or pins, in the case of two coupled portions, as is also the case in the prior art, define a cylindrical or planar winding core 5 (for prismatic windings) with a thickness (or diameter, in the case of a cylindrical core) of less than 1 cm, in particular less than 5 mm.

Conveniently, the apparatus 1 further comprises at least one storage unit or roller buffer 22 arranged downstream of the feed unit 6 and upstream of the drag device 15, and configured to temporarily store a predetermined length of strip 2, 3.

In the specific case shown, the apparatus comprises four buffers 22, one for each strip 2, 3, and each one arranged along the respective feed path P between the respective coil 7, 8 and the respective drag roller 16.

In particular, each buffer 22 is interposed between the relative coil 7, 8 and the relative second member 21.

In use, each buffer 22 is adapted to store a variable amount of strip 2, 3, so as to ensure a continuous production of the apparatus 1.

More precisely, the presence of buffers 22 allows to continuously unwind the strips 2, 3 from their respective coils 7, 8, despite the fact that the winding around the core 5 is intermittent, since at the end of each winding 4 the strips 2, 3, are temporarily blocked and cut off and the wheel 13 is actuated to bring an empty core 5 to the winding station A.

In addition, each buffer 22 allows to continuously feed the strip 2, 3 during a so-called “splicing” operation between two of the same coils 7, 8.

Advantageously, each buffer 22 comprises first fixed rollers 23 and second rollers 24, which are selectively movable closer to or away from the fixed rollers 23 to vary the length (i.e. amount) of strip 2, 3 that can be stored.

Preferably, the second rollers 24 are mounted on a platform 25 sliding on a rail 26 by means of a linear motor (or, alternatively, a ball screw actuator).

It is clear that the apparatus 1 according to the present invention allows to implement a method for winding a strip 2, 3 of material, the method comprising the steps of:
a) feeding the strip 2, 3 along a feed path P from a feeding unit 6 towards a winding core 5 rotatable around a rotation axis;
b) gripping the strip 2, 3 by means of the winding core 5;
c) actuating the winding core 5 in rotation to drag the gripped strip 2, 3 in rotation;
d) winding, by means of the step c) of actuating in rotation, the strip 2, 3 gripped around the rotation axis, so as to form a winding 4 from a predetermined length portion of said strip;
wherein the method also includes the step of:
e) pulling the strip 2, 3 from the feed unit 6 to a position upstream of the winding core 5, along the feed path P;
f) pushing the strip 2, 3, at that position, towards the winding core 5;
g) assisting the winding core 5 in dragging the strip 2, 3 by means of the steps e) of pulling and f) pushing.

Advantageously, but not limitatively, the step g) of assisting comprises actuating the auxiliary drag device 15 in a manner subordinate to the rotation of the winding core 5 about the rotation axis and/or the length of said at least one of the two strips 2, 3 entering the winding 4.

In particular, the drag roller 16 is controlled according to the movement of the winding core 5.

In some non-limiting cases, the drag roller 16 is controlled so as to pull the same amount of strip 2, 3 entering the winding, i.e. the amount of strip 2, 3 pulled by the winding core 5.

In other preferred but not limiting cases, the drag roller 16 is controlled in rotation according to the tilting position of the first dancer roller member 20; in particular, the drag roller 16 is controlled in rotation to maintain a fixed tilting position of the first dancer roller member 20.

In detail, in use, the rotation of the winding core 5 determines a slight change in the tilting position of the first dancer roller member 20, which determines the immediate actuation of the drag roller 16, which is preferably controlled in speed to keep the tilting position of the first dancer roller member 20 fixed.

Thus, as previously said, the drag roller 16 assists the winding core 5 in pulling the strip 2, 3 of material.

Preferably but not limitatively, the drag roller 16 is controlled so that its speed increases as the deviation from a rest position of the first dancer roller member 20 increases. In other words, the greater the deflection of the first dancer roller member 20 relative to the rest position (normally perpendicular to the strip feeding direction), i.e. with the machine at standstill or with the strip 2, 3 being pulled at a constant speed.

In other words, the drag roller 16, more generally the auxiliary drag device 15, is actuated with an alternating motion, thus alternating standstill steps and motion steps (with a variable speed).

Preferably but not limitatively, the speed of the drag roller 16 increases as the thickness of the winding 4 increases (keeping the rotation speed of the winding core 5 constant).

Advantageously, the method also comprises the step of:
h) gripping the strip 2, 3 of material at a position upstream of the winding core 5, along the feed path P;
wherein the steps e) of pulling and f) pushing are performed simultaneously by actuating in rotation a drag roller 16 arranged along the feed path P at said position upstream of the winding core 5.

Advantageously, but not necessarily, the method provides that the pin and the drag rollers are in electric cam 1:1 with each other as regards the linear amount of strip 2, 3 respectively wound and conveyed. In other words, the drag roller 16 is configured to convey the same amount of strip wound by the pin.
Advantageously, but not necessarily, the method further comprises temporarily storing a predetermined length of strip 2, 3 in at least one storage unit 22 arranged downstream of the feeding unit 6, in particular downstream of the coil 7, 8, and upstream of the drag device 15, while keeping the drag roller 16 still and during a movement of the winding core 5 from a winding station A to a closing station B.

More precisely, the method provides filling an aforesaid buffer 22 with an amount of strip 2, 3 at the time of “intermittence” of the winding process, i.e. when winding is stopped and the winding pin is being changed, in order to allow performing operations on the strip 2, 3 upstream of the buffer 22, such as the cutting operations of a station provided with a laser (such as for the creation of end tabs of each cell or for trimming the strip 2, 3).

Advantageously, but not necessarily, the method also provides picking up from the storage unit said previously stored amount of strip 2, 3, keeping the feeding unit 6 still to allow operations downstream of the storage unit 22 itself.

For example, the method provides taking from the buffer 22 the previously stored amount of strip during a splicing operation of the coils 7, 8, so that winding operations can continue uninterrupted.

From an examination of the characteristics of the device 1 and the winding method realized according to the present invention, the advantages they allow to obtain are clear.

In particular, due to the presence of the drag rollers 16, the pulling stresses to which the pin of the winding core 5 is subjected are reduced compared to the case where no auxiliary drag roller 16 is provided.

In addition, since there is a drag roller 16 for each strip 2, 3, such a load is distributed over each one of the feed paths P, i.e. over each one of the rollers 16, further reducing the stresses to which the pin of the core 5 is subjected.

Thus, the service life of each winding core 5 is increased, resulting in a significant reduction in the total costs to be incurred for the maintenance of the apparatus 1.

In addition, there is no need to thicken the pin of the core 5, which makes it possible to obtain more compact and higher capacity windings 4 with the same dimensions.

In addition, as the stresses on the pin of the core 5 are reduced, the rotation speed of the latter may be increased without any problems, i.e. the apparatus 1 can operate at a higher production speed.

It is clear that modifications and variations can be made to the apparatus 1 and winding method herein described and shown without departing from the scope of protection defined by the claims.

1. Apparatus (1) for winding at least two strips (2, 3) of material for the production of electrical energy storage devices, the apparatus (1) comprising:
a winding core (5) rotatable about a rotation axis, configured to grip at least said two strips (2, 3) and actuatable in rotation for dragging the gripped strips (2, 3) and thereby forming a winding (4) about the rotation axis from a predetermined length portion of each of said strips (2, 3); and
a feeding unit (6) for feeding at least one of the two strips (2, 3) of material to the winding core (5) along a respective feed path (P) extending from the feeding unit (6) to the winding core (5);
wherein the apparatus (1) further comprises an auxiliary drag device (15) interposed between the feeding unit (6) and the winding core (5), along said feed path (P), and configured to pull the at least one of the two strips (2, 3) of material from the feeding unit (6) and push it towards the winding core (5), so as to assist the winding core (5) in dragging the at least one of the two strips (2, 3).

2. Winding apparatus as claimed in claim 1, wherein the auxiliary drag device (15) is configured to grip the at least one of the two strips (2, 3) and comprises a drag roller (16) arranged along said feed path (P) in a position downstream of the feeding unit (6) and upstream of the winding core (5), said drag roller (16) being actuatable in rotation to pull the at least one of the two strips (2, 3) gripped by the feeding unit (6) and feed it towards the winding core (5).

3. Winding apparatus as claimed in claim 2, wherein the drag device (15) further comprises a counter roller (18) arranged adjacent to the drag roller (16) and configured to press against an outer lateral surface (16a) of the drag roller (16) to determine said gripping of the at least one of the two strips (2, 3) in a position upstream of the winding core (5).

4. Winding apparatus as claimed in claim 3, wherein the auxiliary drag device (15) includes an actuator (19) for moving the counter roller (18) towards and away from the outer lateral surface (16a) of the drag roller (16) to determine an adjustment of the gripping pressure of the at least one of the two strips (2, 3) between the counter roller (18) and the drag roller (16).

5. Winding apparatus as claimed in claim 4, wherein said actuator (19) is of the hydraulic type.

6. Winding apparatus as claimed in claim 2, and further comprising a first dancer roller member (20) arranged along said feed path (P) downstream of the drag roller (16) and upstream of the winding core (5) and controllable in tilting to adjust a tension of the at least one of the two strips (2, 3) between the drag roller (16) and the winding core (5).

7. Winding apparatus as claimed in claim 6, and further comprising a second dancer roller member (21) arranged along said feed path (P) downstream of the feeding unit (6) and upstream of the drag roller (16) and controllable in tilting to adjust a tension of the at least one of the two strips (2, 3) between the feeding unit (6) and the drag roller (16).

8. Winding apparatus as claimed in claim 6, wherein at least the first dancing roller member (20) comprises at least one pair of dancer rollers (20a, 20b) integral in tilting with one another, said feed path (P) passing through the first dancer roller member (20) in such a way that each dancer roller (20a, 20b) of said pair supports in unwinding the strip (2, 3) of material.

9. Winding apparatus according to claim 6, wherein the drag roller (16) is configured to be controlled in rotation according to the tilting position of the first dancer roller member (20).

10. Winding apparatus as claimed in claim 2, wherein the feeding unit (6) comprises:
a first feeding device (7) configured to feed two separator strips (3) to the winding core (5) along two respective feed paths (P); and
a second feeding device (8) configured to feed two electrode strips (2) to the winding core (5) along two respective feed paths (P);
and wherein the winding apparatus (1) comprises a plurality of said drag rollers (16), at least one for each separator or electrode strip (2, 3), each arranged along the respective feed path (P) downstream of the relative feeding device (7, 8) and upstream of the winding core (5).

11. Winding apparatus as claimed in claim 1, wherein the drag roller (16) is located at a non-zero distance from the winding core (15), measured along said feed path (P), less than ½ of the total length of the feed path (P), preferably less than ⅓ of the total length of the feed path (P), even more preferably less than ¼ of the total length of the feed path (P), even more preferably less than ⅕ of the total length of the feed path (P), more specifically less than ⅙ of the total length of the feed path (P).

12. Winding apparatus as claimed in claim 1, wherein the auxiliary drag device (15) is actuated in a manner subordinate to the rotation of the winding core (5) about the rotation axis and/or the length of said at least one of said at least one of the two strips (2, 3) entering the winding (4).

13. Winding apparatus as claimed in claim 1, and further comprising a roller storage unit (22) arranged downstream of the feeding unit (6) and upstream of the auxiliary drag device (15), and configured to temporarily store a predetermined length of the at least one of the at least one of the two strips (2, 3).

14. Winding apparatus as claimed in claim 13, wherein the storage unit (22) comprises first fixed rollers (23) and second rollers (24) selectively movable towards or away from the fixed first rollers (23) for varying the storable length of the at least one of the two strips.

15. Method of winding at least two strips (2, 3) of material, the method comprising the steps of:
a) feeding at least one of the two strips (2, 3) along a feed path (P) from a feeding unit (6) towards a winding core (5) rotating about a rotation axis;
b) gripping said at least one of the two strips (2, 3) by means of the winding core (5);
c) actuating in rotation the winding core (5) to drag in rotation said at least one of the two strips (2, 3);
d) winding, by means of step c) of actuating in rotation, said at least one of the two strips (2, 3) gripped about the rotation axis, so as to form a winding (4) from a portion of predetermined length of said at least one of the two strips (2, 3);
wherein the method also includes the step of:
e) pulling said at least one of the two strips (2, 3) from the feeding unit (6) at a position upstream of the winding core (5), along the feed path (P);
f) pushing said at least one of the two strips (2, 3), at such position, towards the winding core (5);
g) assisting the winding core (5) in dragging said at least one of the two strips (2, 3) by means of the steps e) of pulling and f) of pushing.

16. Winding method as claimed in claim 15, and comprising the step of:
h) gripping said at least one of the two strips (2, 3) of material in a position upstream of the winding core (5), along the feed path (P);
wherein the steps e) of pulling and f) of pushing are performed simultaneously by actuating in rotation a drag roller (16) arranged along the feed path (P) at said position upstream of the winding core (5).

17. Winding method according to claim 15, wherein the step g) of assisting comprises actuating the auxiliary drag device (15) in a manner subordinate to the rotation of the winding core (5) about the rotation axis and/or the length of said at least one of the two strips (2, 3) entering the winding (4).
